(19) United States
(12) Patent Application Publication
(10) Pub. No.: US 2013/0127312 A1
(43) Pub. Date: May 23, 2013

(54) CHILD SAFETY DEVICE FOR FURNITURE

(71) Applicants: Francis Chedozeau, Annemasse (FR); Sandrine Chedozeau, Annemasse (FR)

(72) Inventors: Francis Chedozeau, Annemasse (FR); Sandrine Chedozeau, Annemasse (FR)

(21) Appl. No.: 13/643,771

(22) PCT Filed: Apr. 26, 2011
(86) PCT No.: PCT/FR2011/050951

§ 371 Date: Jan. 10, 2013

(30) Foreign Application Priority Data
Apr. 27, 2010 (FR) 1053196

(51) Int. Cl. A47B 77/04; E05B 65/46; A47B 88/04

(52) U.S. Cl. CPC A47B 77/04; A47B 88/04; E05B 65/46
USPC 312/236; 312/270.3

(57) ABSTRACT

Safety furniture unit (1) which includes at least one sliding drawer (2), the enclosure (20) of which is intended for containing products, and which includes at least one safety device preventing domestic hazards, said drawer including means making it difficult or even impossible for a child to access the contents thereof, these means comprising a closing wall (6) mobile between two positions, namely a closed position and an open position and vice versa, said mobile wall (6) being slidably mounted between the side walls (4c, 4d) of the drawer, characterized in that said mobile closing wall (6) engages with the front wall (4a) of the drawer by means of a safety latch (21). Said latch is such that, when in a locked position, an action opposite that performed to move the wall and place the wall in the position that enables access to the contents of the drawer needs to be carried out.

The present invention relates to a safety device for furniture, more specifically furniture including at least one safety device preventing domestic hazards, in particular access to the contents of a drawer and/or to a hot plate.

Domestic accidents are very common and have particularly adverse consequences. Children are usually the victims of these accidents, as in the case, for example, of a child accessing the contents of a drawer containing dangerous products, such as, for example, knives, drugs, cleaning products and toxic chemicals and so on. This is also the case of a child touching a hot plate or a product that is cooking.

This invention aims to resolve the disadvantages mentioned above and provides an improvement for furniture making it possible to avoid or eliminate the domestic accidents listed above.

Thus, the safety furniture unit comprising at least one sliding drawer of which the enclosure is designed to contain products, is, according to the invention, characterized in that it includes at least one safety system preventing domestic hazards.

According to an additional feature, the furniture includes at least one safety drawer including means making it difficult to access its contents.

According to another feature, the drawer includes a closing wall that is mobile between two positions, namely a closed position and an open position, or vice versa.

According to the preferred embodiment of the invention, the mobile wall slides between the side walls of the drawer, and cooperates with the front wall of the drawer by means of a safety latch. Said latch is such that, when in the locked position, an action opposite that performed to move the wall and place the wall in the position that enables access to the contents of the drawer needs to be carried out.

It should be specified that to allow the user to perform the action enabling the latch to be unlocked, gripping means are provided, such as, for example, a gripping hole in the mobile closing wall, while, to enable the mobile locking wall to be moved forward from its locked closing position to its position of unlocking the latch, a release recess is provided in the rear face of the front wall of the drawer.

According to an additional feature, so as not to leave the mobile closing wall in its open position when the drawer is pushed back to its stowed position, means are provided for automatically causing the mobile closing wall to be re-closed and locked in the closed position.

According to another embodiment, the safety furniture unit includes a hot plate as well as a mobile separation wall preventing a child from accessing the hot plates or utensils placed there, and said mobile protection and separation wall is mounted so that it can pivot about a horizontal axis to move from an inactive position of non-use, in which it is folded down, to a position of protection, in which it is raised upwards so as to be placed in a substantially horizontal position, while the protection and separation wall is locked in its active position, for example, with a slide-locking system.

Other features and advantages of the invention will become clear in the following description with reference to the appended drawings provided for illustrative and non-limiting purposes.

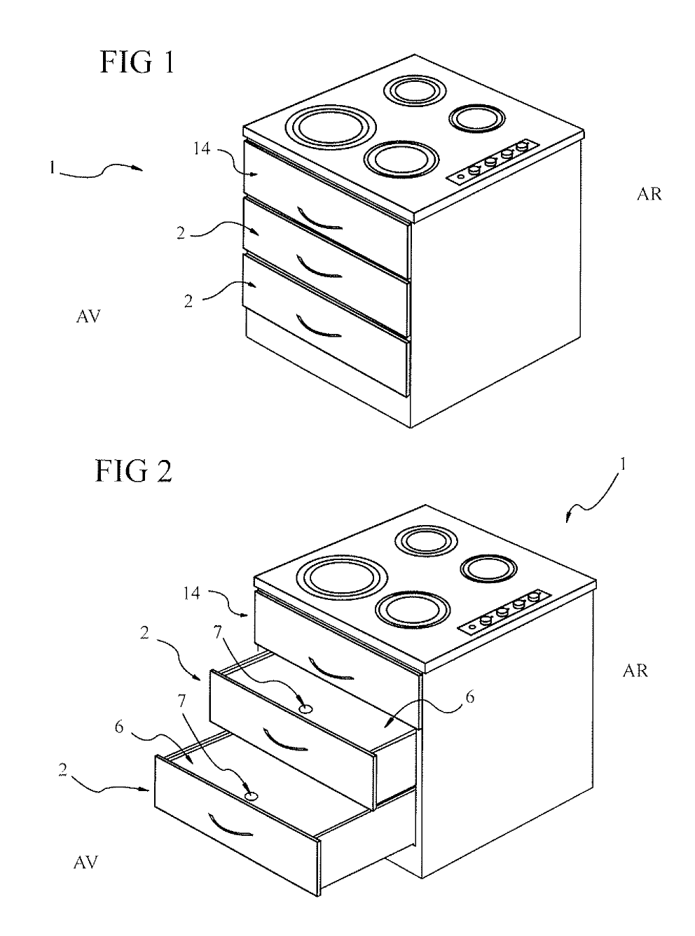

FIG. 1 is a perspective view of the furniture of the invention, of which the drawers are in the retracted position.

FIG. 2 is a perspective view of the furniture of the invention, of which one of the drawers is in the forward-slid position, but with its mobile closing wall in the locked closed position, preventing access to the contents of the drawer.

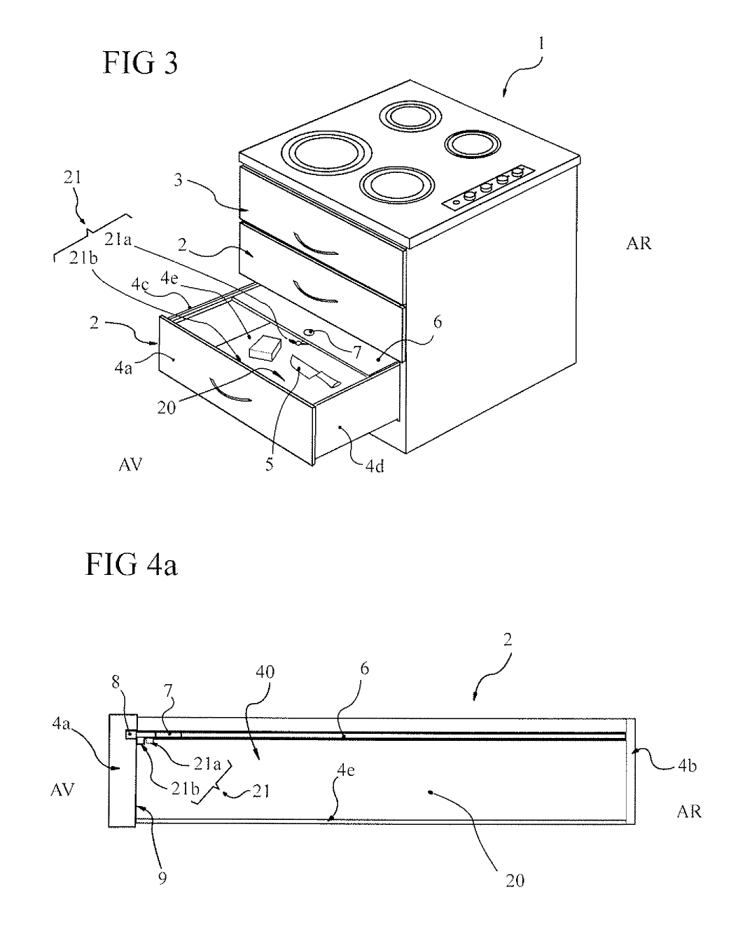

FIG. 3 is a perspective view of the furniture of the invention, of which one of the drawers is in the forward-slid position, but with its mobile closing wall in the pulled-out open position, allowing access to the contents of drawer.

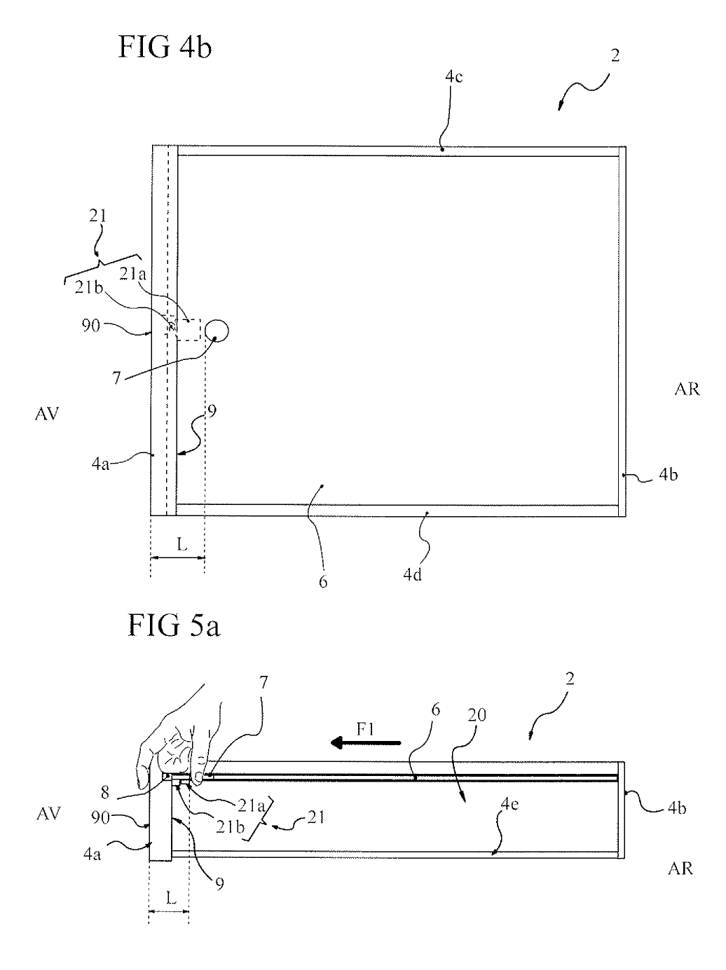

FIG. 4a is a side view according to an axial section of the drawer of the invention, with its mobile closing wall in the locked closed position.

FIG. 4b is a top view of the drawer of the invention, with its mobile closing wall in the locked closed position.

FIGS. 5a, 5b are side views similar to FIG. 4, illustrating the process of opening the mobile closing wall.

FIG. 5a shows the drawer with the forward action of the user wishing to access the contents of the drawer.

FIG. 5b shows the drawer with its mobile closing wall in the open position and thus pulled out allowing access to the contents of the drawer.

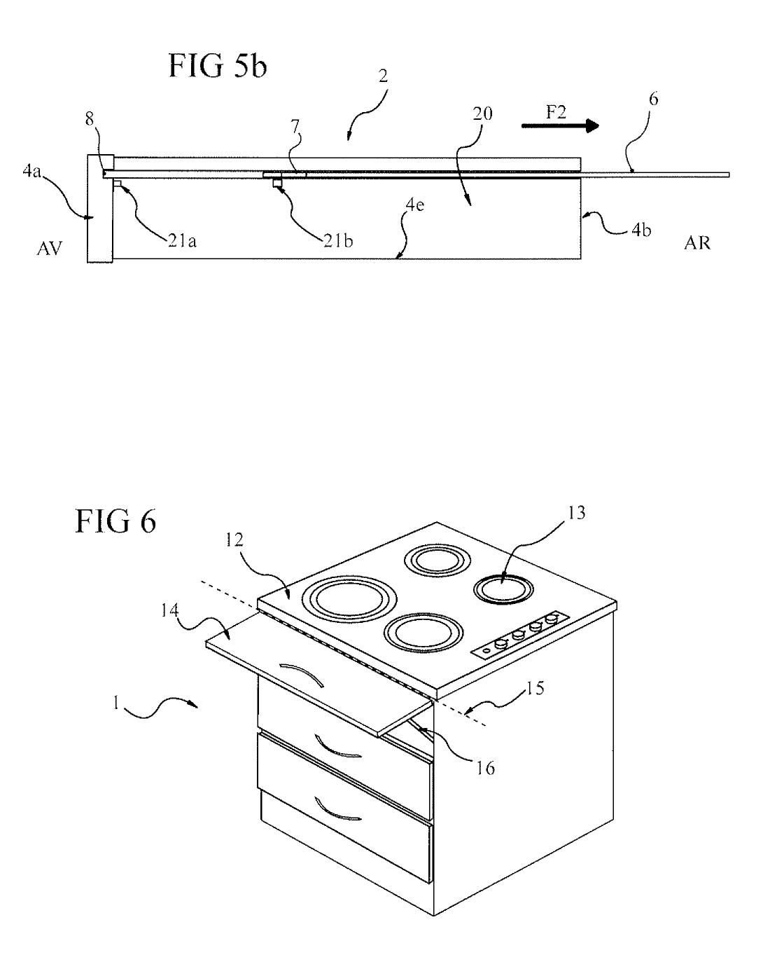

FIG. 6 is a perspective view showing an additional safety system for a furniture unit that includes, in its upper portion, a hot plate.

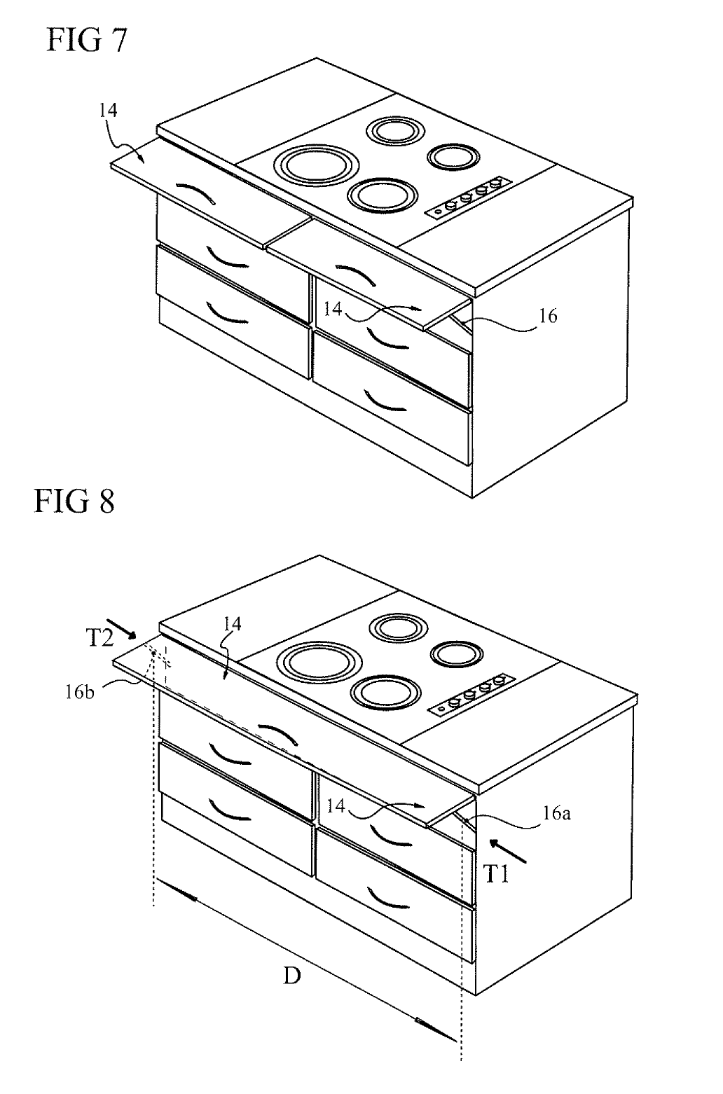

FIG. 7 is perspective view showing an alternative embodiment of FIG. 6.

FIG. 8 is an alternative shown in perspective.

According to the invention, the safety furniture unit with the general reference (1) includes at least one safety drawer (2) and means making access to its contents difficult or even impossible for a young child.

Said safety furniture unit, when it is a low element, includes a hot plate and a separation wall (14) preventing a child from accessing the hot plates or utensils placed on it.

The drawer of the invention (1) has the shape of a box forming a container open at the top. For this purpose, the drawer (1) is peripherally bordered, in a manner known in itself, by peripheral vertical walls (4a, 4b, 4c, 4d), namely a front wall (4a), a rear wall (4b) and two sliding side walls (4c, 4d), a left side wall (4c) and a right side wall (4d). Said drawer further includes, and in a manner known in itself, a bottom wall (4e). Said box thus forms a container in which hazardous products (5) are stored. These products are, for example, drugs, dangerous tools, cleaning products and so on, stored in the enclosure (20) of the drawer. It is therefore important to make access to the contents of the drawer difficult or impossible to children.

For this purpose the drawer includes a mobile closing wall (6). This wall is a wall that, for example, is in the form of a panel extending horizontally at the upper level of the enclosure so as to close the upper portion like a closure lid. The mobile closing wall is, for example, able to slide with respect to the body of the drawer, between the two side walls (4c, 4d) so as to take two positions, namely a closed position and an open position, and vice versa.

In its closed position, the mobile closing wall (6) is in the forward-slid position (AV) to close off the containment space of the drawer as is illustrated in FIGS. 2, 4a, 4b, 6.

In its open position, the closing wall is in its backward-slid position (AR), to allow access to the contents of the drawer, as illustrated in FIGS. 3 and 5b.

According to one feature of the invention, the drawer comprises means making it difficult or impossible for a child to slide the closing wall from its closed position to its open position.

To this end, the mobile closing wall operates in conjunction with the box of the drawer by means of a safety latch (21), and more precisely with the internal side of the front wall. Said latch is designed so that, when in the locked position, an action opposite that performed to move the wall and place the wall in the position that enables access to the contents of the drawer needs to be carried out. The safety latch (21) consists of a pivoting lever (21a) of which the end is intended to cooperate with a finger hook and lock (21b). The pivoting lever works with a resilient system to allow two stable positions to be taken, namely an open position and a locking position according to which the end of the lever is engaged with the finger lock, given that the lever with its pivoting and its resilient system constitutes a so-called “toggle system”. According to the illustrated embodiment, the pivoting lever (21a) is fixed under the mobile closing wall (6) while the finger hook and lock (21b) is fixed on the rear side (9) of the front wall (4a).

Thus, with this latch, the user wishing to access the contents of the box while the closing wall is in its closed position must first perform a forward action (AV) according to F1, the force of which action is great enough to prevent children from producing it, given their limited strength. It should be specified that the unlocking action according to (F1) is opposite the action of sliding (F2) the closing wall toward the back.

In order to allow the user to perform the action according to (F1) enabling the latch to be unlocked, gripping means are provided, such as, for example, a gripping hole (7) in the mobile closing wall. Of course, according to an alternative embodiment, the gripping hole includes a lining, consisting of a peripheral bushing. To prevent a child from moving the mobile closing wall forward while it is in the closed position, the distance (L) between the front side (90) and the area of action (70) is such that a child cannot press on the front side (90), and the zone of action (70) at the same time. The distance (L) is greater than 6 centimeters and, for example, between 6 to 11 centimeters.

It should be added that, to enable the mobile closing wall to move forward according to (F1) from its locked closed position to its position of unlocking of the latch, a release recess (8) is provided in the rear side (9)_of the front wall (4a) of the drawer.

So as not to leave the mobile closing wall in its open position when the drawer is pushed back to its stowed position, means are provided so as to automatically cause the mobile closing wall to be re-closed and locked in the closed position.

FIG. 6 is a perspective view showing an additional safety system for a furniture unit that includes, in its upper portion (12), a hot plate (13). To this end, a mobile protection and separation wall (14) is mounted so as to pivot about a horizontal axis (15) so as to move from its inactive position of non-use to its active position of protection.

In the inactive position, said protection and separation wall (14) is folded down, while, in its active protection position, it is raised up so as to be placed in a substantially horizontal position as shown in FIG. 6.

It is to be mentioned that the protection and separation wall (14) is locked in its active position, for example, by means of a slide-lock (16). It is understood that, in its active position, the protective wall is raised and the child is kept away from the heat of the hot plate, and therefore cannot come into contact with any dishes.

FIG. 7 is an alternative wherein the furniture unit includes two adjacent protection and separation walls (14) so as to keep the child wanting to approach the hot plate even further away.

To improve safety, the wall includes two lateral sliding systems as shown in FIG. 8, which must be operated simultaneously, as in T1 and T2, to unlock the wall, to release it and cause it to pivot down to its inactive position. For this purpose, the distance (D) between the two sliders is greater than 90 centimeters, for example between 90 and 120 centimeters, making it impossible for children to operate the two sliders simultaneously, as their arms are not long enough.

1. A safety furniture unit comprising at least one sliding drawer, the an enclosure of the at least one sliding drawer being intended for containing products, and including at least one safety device preventing domestic hazards, the drawer comprising a closing wall mobile movable between a closed position and an open position, the closing wall being slidably mounted between the side walls of the drawer, the closing wall engaging with a front wall of the drawer via a safety latch, wherein when the latch is in a locked position, an action opposite that performed to move the closing wall and place the closing wall in a position that enables access to the contents of the drawer needs to be carried out.

2. The safety furniture unit according to the previous claim 1, wherein the safety latch consists of a pivoting lever having an end is designed to cooperate with a finger hook and lock.

3. The safety furniture unit according to claim 2, wherein the pivoting lever is urged by a resilient system to take two stable positions, the two stable positions including an opening position and a locking position in which the end of the lever is engaged with the finger lock, the pivoting lever and the resilient system forming a toggle system.

4. The safety furniture unit according to claim 3, wherein the pivoting lever is fixed under the mobile closing wall and the finger hook and lock is fixed on a back side of the front wall.

5. The safety furniture unit according to claim 4, further comprising gripping means allowing a user to perform an action to unlock the latch.

6. The safety furniture unit according to claim 5, being adapted to prevent a child to displace the closing wall forward while the closing wall is in the closed position, a distance between front side of the front wall and a zone of action being such that a child cannot press on the front side and the zone of action at the same time.

7. The safety furniture unit according to claim 6, wherein the distance is greater than 6 centimeters.

8. The safety furniture unit according to claim 1, wherein to enable the closing wall to be moved forward from locked the closed position to a position of unlocking of the latch, a release recess is provided in the rear back side of the front wall of the drawer.

9. The safety furniture unit according to claim 1, wherein so as not to leave the closing wall in the open position when the drawer is pushed back into a stowed position, means are provided in order to automatically cause the closing wall to be re-closed and locked in the closed position.

10. The safety furniture unit according to claim 9, further comprising a hot plate and a separation wall preventing a child from accessing the hot plate or other utensils placed on the hot plate.

11. The safety furniture unit according to claim 10, wherein the separation wall is mounted so as to pivot about a horizontal axis so as to move between an inactive position of non-use, in which the separation wall is folded down, and an active position of protection, in which it the separation wall is raised upwards so as to be placed in a substantially horizontal position, and the separation wall is locked in the active position by a slide-locking system.

12. The safety furniture unit according to claim 11, wherein the separation wall includes two lateral sliders that have to be operated simultaneously to unlock the separation wall, to release it the separation wall and to cause the separation wall to pivot down into its the inactive position.

13. The safety furniture unit according to claim 12, characterized in that the wherein a distance between the two sliders is more than 90 centimeters.

14. The safety furniture according to claim 5, wherein the gripping means include a gripping hole in the closing wall.
